(19) United States
(12) Patent Application Publication
(10) Pub. No.: US 2002/0093493 A1
(43) Pub. Date: Jul. 18, 2002

(54) Hand held internet access/personal digital assistant/cellular communication device

(75) Inventors: Ben-Zion Michaeli, Holon (IL); Gal Gilor, Ramat Gan (IL); Aviv Dagani, Shoham (IL)

Correspondence Address: G. E. EHRLICH (1995) LTD., c/o ANTHONY CASTORINA, SUITE 207, 2001 JEFFERSON DAVIS HIGHWAY, ARLINGTON, VA, 22202, US

(73) Assignee: E-mobile Israel Ltd.

(21) Appl. No.: 09/815,001

(22) Filed: Mar. 23, 2001

Related U.S. Application Data
(60) Provisional application No. 60/261,830, filed on Jan. 17, 2001.

(51) Int. Cl. G09G 5/00

(52) U.S. Cl. 345/173

(57) ABSTRACT

A small hand held and operable device having a touch sensitive screen with an aspect ratio of about 4:3 and constituting at least 50% of a front face of the device; a rear bridge forming an arch constructed and positioned to allow a user to securely grip the device; and a digital camera being movable relative to the device. A number of applications of the device are described, including accessing the Internet, processing data, and communicating with another device which is a user client at the disposal of another user.

### FIELD AND BACKGROUND OF THE INVENTION

The present invention relates to hand held computing devices, and more particularly, to a combined Internet access/personal digital assistant (PDA)/cellular communication device.

Businessmen and women and other professionals typically require immediate access to a lot of information during a busy workday or while traveling. Many fill this need by using palmtop computer systems which are small in size yet have a meaningfull capacity for information storage. In recent years, palmtops have substantially replaced diaries and address directories in book form. Palmtop computers are small compact computers that can fit in the palm of a hand and can perform personal informational management tasks such as address book, daily organizer and “to do” list. Palmtops are often characterized by a relatively large touch display screen which serves as both an input and output interface.

Palmtop computers continue to become more powerful and more compact, incorporating increasingly sophisticated technology, allowing the expansion of their capabilities and becoming more versatile and user friendly. Examples of new capabilities can be found in U.S. Pat. No. 5,900,875 which shows a new method and apparatus for interacting with a palmtop computer, and U.S. Pat. No. 5,941,648 which teaches an improved keyboard, and U.S. Pat. No. 6,163,274 which shows a remotely updateable Personal Digital Assistant. Indeed, the market abounds with Personal Digital Assistant type devices that can recognize handwriting, store data, conduct phone calls and access the Internet. Examples include the Newton produced by Apple, the Palm Pilot by 3-COM, the Cassiopeia by Cassio and the WebPAD by National Semiconductor.

However, there does not exist a palmtop computer that incorporates a built in digital camera that is movable relative to the device so that it may capture scenes both in front of and in back of the device. A further drawback of existing palmtop computers is that they are typically uncomfortable to hold and do not provide a secure gripping mechanism. There is, therefore, a widely recognized need for a small handheld computer devoid of the above limitations.

### SUMMARY OF THE INVENTION

According to one aspect of the present invention there is provided a hand held and operable Internet access/personal digital assistant (PDA)/cellular communication device comprising a housing being sufficiently small so as to be held by one hand of a user; and a rear bridge connected to or integrally formed with the back of the housing which is so constructed and positioned so as to allow a user to securely grip the device.

According to a further aspect of the present invention there is provided a hand held and operable Internet access/personal digital assistant (PDA)/cellular communication device comprising a housing being sufficiently small so as to be held by one hand of a user; and an integral or mountable digital camera pivotally engaged by the housing, the camera being movable relative to the device such that the camera is positionable in at least one direction facing a first field of view in front of the front face of the device and re-positionable in at least one direction facing a second field of view behind the back of the device.

According to features in the described preferred embodiment, the device is designed and configured for accessing the Internet, processing data, and communicating with at least one user client at the disposal of a second user.

According to features in the described preferred embodiment, the device comprises a touch screen engaged in the housing which serves as a display screen and also as a user input interface

According to features in the described preferred embodiment, the touch screen has horizontal and vertical dimensions defining an aspect ratio of about 4:3. As used herein throughout, “about” means ±20%.

According to features in the described preferred embodiment, the touch screen constitutes at least 50%, preferably more, of the front face of the device.

According to features in the described preferred embodiment, communication between the device and at least one user client is effected via a communications network.

According to features in the described preferred embodiment, the at least one user client is selected from the group consisting of a computer, a cellular telephone and a personal digital assistant.

According to features in the described preferred embodiment, the device comprises a data communication port.

According to features in the described preferred embodiment, the device comprises a memory for storing data.

According to features in the described preferred embodiment, the touch sensitive screen displays a virtual keyboard or serves as a sensor for character recognition.

According to features in the described preferred embodiment, the device comprises a user input interface which further includes one or more buttons disposed in the front face of the housing, an integral joystick operable by a user and a microphone integral to the housing.

According to features in the described preferred embodiment, the device comprises an output interface comprising the display screen and a speaker.

According to features in the described preferred embodiment, the device comprises a display screen being capable of displaying a full width of a Web page.

According to features in the described preferred embodiment, the device is designed and configured for communicating with a base unit.

According to features in the described preferred embodiment, the device is designed and configured for communicating with a server.

The present invention successfully addresses the shortcomings of the presently known palmtop computing devices by combining Internet access/data processing/communication capabilities with a movable digital camera, thus providing a versatile device that is comfortably and securely held with one hand by a user.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a front view of a device constructed in accordance with the teachings of the present invention;

FIG. 2 illustrates a bottom view of the device of FIG. 1;

FIG. 3 illustrates a back view of the device of FIG. 1;

FIG. 4 illustrates a top view of the device of FIG. 1;

FIG. 5 illustrates a left side view of the device of FIG. 1;

FIG. 6 illustrates a right side view of the device of FIG. 1;

FIG. 7 illustrates a front perspective view of the device of FIG. 1;

FIG. 8 illustrates a back perspective view of the device of FIG. 1; and

FIG. 9 is a black box diagram of the communication system employed according to the present invention.

### DESCRIPTION OF THE PREFERRED EMBODIMENTS

The present invention is of a hand held Internet access/personal digital assistant/communication device that can be securely held in one hand by means of a rear bridge, is able to display a full width of a Web page and includes an integral digital camera which is movable relative to the device and can capture static or moving images in a direction facing the front of the device and in a direction facing the back of a device and optionally in any direction therebetween.

The principles and operation of a device according to the present invention may be better understood with reference to the drawings and accompanying descriptions.

Before explaining at least one embodiment of the invention detail, it is to be understood that the invention is not limited in its application to the details of construction or to the arrangement, location or configuration of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

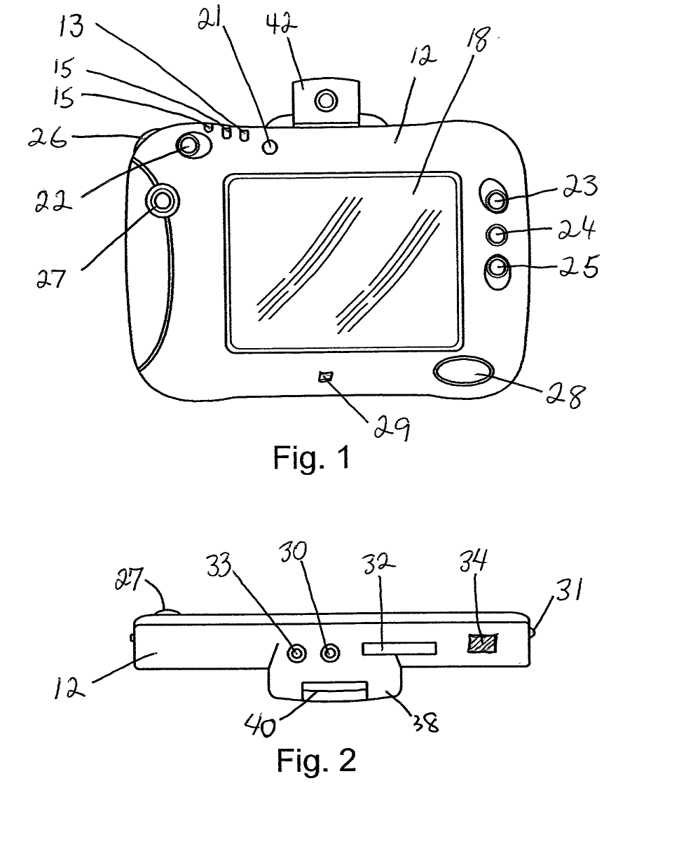

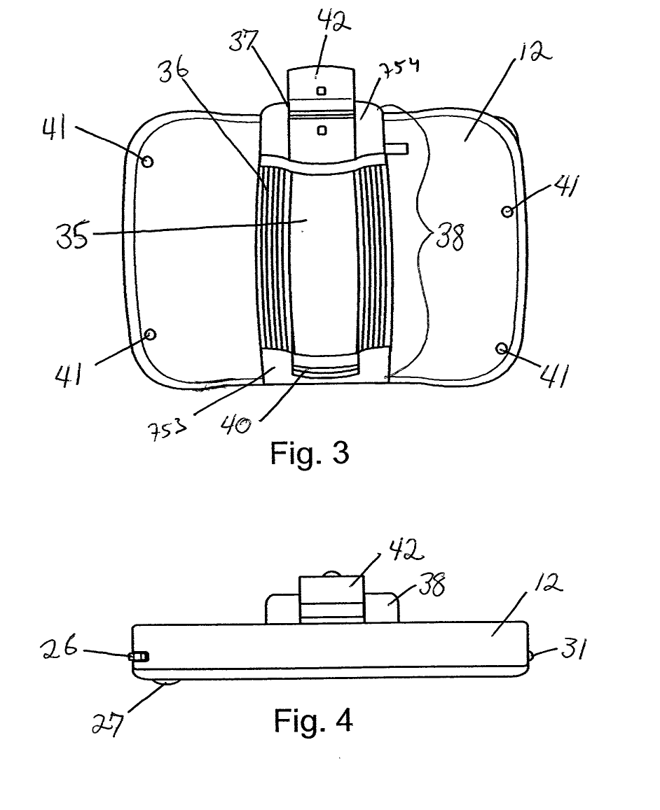

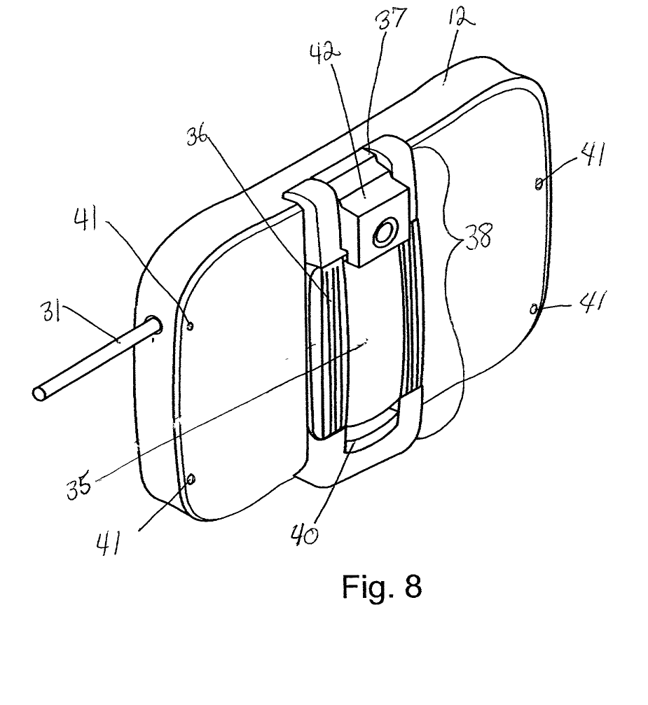

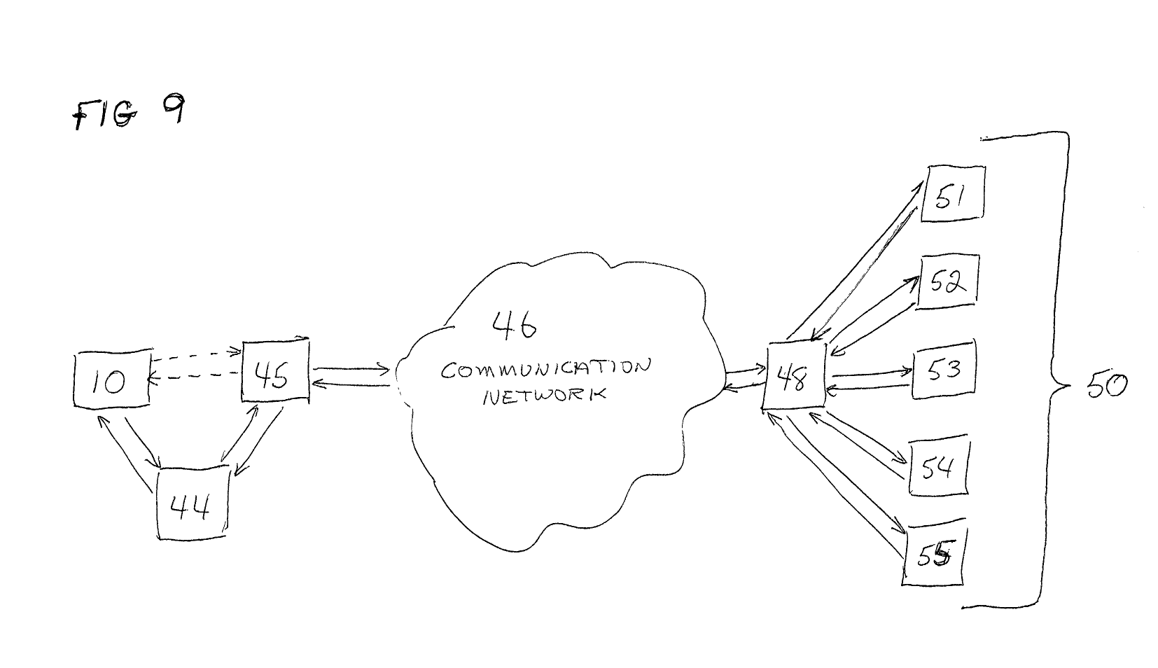

Referring now to the drawings, FIGS. 1-8 illustrate a hand held device in accordance with the teachings of the present invention, which is referred to hereinbelow as device 10. Device 10 includes a housing 12 which is sufficiently small in size to be easily held in one hand or carried in the pocket, bag or purse of a person. Housing 12 is preferably formed in two parts which are held together by body assembly screws 41. Housing 12 engages therein a touch sensitive screen 18, hereinafter screen 18, which constitutes at least 50%, preferably at least 60%, more preferably at least 70%, still preferably at least 80%, most preferably at least 90%, ideally 90%-100% of the area of the front face of device 10. Screen 18 allows a user to input data, serving as one element of a user input interface, hereinafter generically referred to as input interface 14. A detailed description of the structure and function of input interface 14 is provided hereinbelow. Screen 18 also displays data, serving as one element of an output interface, hereinafter generically referred to as output interface 16. Housing 12 also engages integral status indicators in the form of LED's 15, a light sensor 13, which governs the brightness of screen 18 and an external power supply port 33.

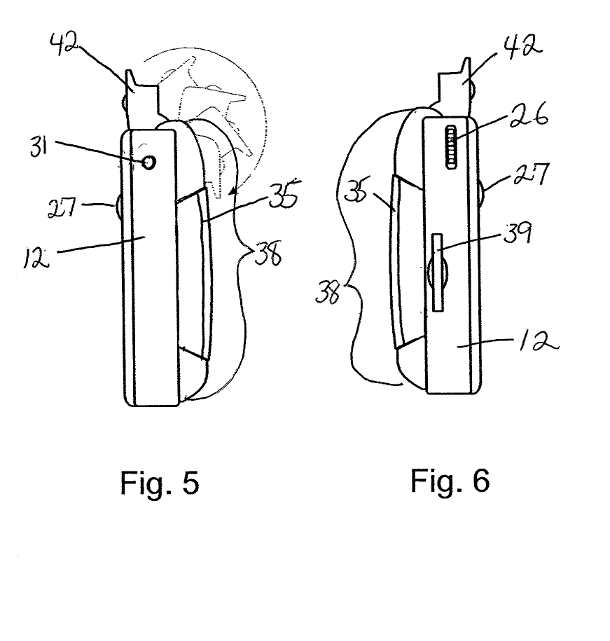

As best seen in FIGS. 5 and 6, device 10 also includes a rear bridge 38 which is connected to or integrally formed with housing 12, centrally disposed and vertically (top-to-bottom) oriented, extending from the back of device 10. Bridge 38 is constructed and positioned such that a gap is formed between bridge 38 and housing 12 in order to allow a user to securely grasp device 10. According to the illustrated preferred embodiment, the gap between bridge 38 and housing 12 is about 5-9, most preferably about 7 millimeters wide. Alternative embodiments may have gaps of differing dimensions and configurations in order to provide differing means of achieving a secure grip. Bridge 38 is typically formed with a nonslip gripping surface which, in the preferred embodiment, includes a series of longitudinal ridges 36.

According to a preferred embodiment of the present invention, bridge 38 or portions thereof serve also to hold a battery 35 which, in the preferred embodiment, forms a portion thereof. Thus, bridge 38 includes at its lower extremity a battery attachment interface 753, which contains a snap engagement release lever 0 and at its upper extremity attachment interfaces 754 for battery 35 and camera 42. Battery 35 preferably forms a fluid curvilinear surface with bridge 38 providing a comfortable hand hold.

Device 10 further includes an integral digital camera 42, preferably a digital video and/or still camera, disposed on housing 12 at the upper end of bridge 38. One possible attachment configuration of camera 42 to housing 12 is shown in FIG. 5. In accordance with a preferred embodiment of the present invention, camera 42 is pivotally attached to housing 12 by means of hinge 37 which allows camera 42 to rotate in an arc, preferably in excess of 180 degrees, relative to housing 12. The rotational arc described is illustrated in FIG. 5 and allows the lens aperture of camera 42 to be oriented perpendicular to the front face of device 10, thus enabling camera 42 to capture images that appear in front of device 10, for example, the user of device 10 in the act of using device 10. The rotational arc described also allows the lens aperture of camera 42 to be oriented perpendicular to the back of device 10, thus enabling camera 42 to capture images that appear behind the back of device 10. Further, as specifically shown in FIG. 5, the lens aperture of camera 42 can be oriented toward any point within the described rotational arc, thus allowing camera 42 to capture images of whatever appears at any point in an arc spanning at least 180 degrees that begins in the front of device 10, passes the top of device 10 and ends in the back of device 10. One end of the rotational arc described places camera 42 in its stowed inoperative position, resting above battery 35 on the back side of device 10. Stepwise rotation of camera 42 is also envisaged.

Camera 42 is preferably capable of capturing still or video images. The function of camera 42 and the data collected thereby may be integrated with the other functions of device 10. For example, video images captured by camera 42 may be transmitted to a user in communication with the user of device 10, or uploaded to a Web site. The images captured by camera 42 may also be stored and retrieved pursuant to the PDA function of device 10; or transmitted to a remote user client having the requisite video capability through a communications network. A detailed description of the construction and function of the communication system employable by device 10 is provided hereinbelow. The integration of camera 42 allows device 10 as a whole to serve as a digital camera, and because camera 42 may be rotated, device 10 serves also for cellular/internet based video conferencing.

According to the described preferred embodiment, device 10 is a multifunctional device, capable of accessing the Internet, processing data, and communicating with another user. Carrying out each of the above functions requires the use of a communications network.

FIG. 9 illustrates the communication system employed by device 10, hereinafter referred to as system 43. System 43 includes a server 45 which links device 10 to communications network 46. The link between device 10 and server 45 may be direct or may be via a base unit or docking station 44. Communication between device 10 and base unit 44 is preferably by wireless communication such as Infrared or Radio Frequency. Device 10 can include a “blue tooth” chip, which will enhance its capability to communicate from locations remote from its home server. Direct communication between device 10 and server 45, which does not rely upon base unit 44, could be effected alternatively via cellular communication or hard wire (telephony, cable, etc.). For purposes of such communication, device 10 preferably includes both a hard wire communication port and a wireless communication port 34. Server 45 communicates with communications network 46 over a hard wire link, preferably via a WAN, LAN or a dialup connection. Other communication modes are also applicable.

With respect to the communication function in which device 10 communicates with another user, a dedicated communication server 48 provides the link between communications network 46 and a user client 50 operated by that user. The link between communications network 46 and user client 50 is effected via hard wire or wireless communication in accordance with the capability of the relevant user client.

As used herein, the term “server” refers to a computing platform, such as a personal computer, workstation or mainframe capable of processing, storing and communicating information over a communications network. The term “communications network” preferably refers to cellular networks and to the Internet, although device 10 can also communicate within Intranets or Extranets or any other open or closed communications network. The phrase “user client” generally refers to a computer 51, PDA 52, cellular telephone 53, facsimile device 54 and/or Web TV 55, each being a unique device type as classified according to intended use, mode of communication, mobility and/or the like.

All of the functions of device 10 are effected by a user via input interface 14. In the example shown in the drawings, input interface 14 consists of four elements: screen 18, control buttons 20, joystick 24 and integral microphone 29. Moreover, device 10 has open architecture, incorporating an integral data connector port 32 allowing the application of external input devices such as a keyboard and mouse and jack 30 which supports an external microphone.

Screen 18 is the primary interface for user input, and includes a touch sensitive digitizer pad that can detect contact by any type of pointer, from a stylus to a simple finger touch. Device 10 includes a stylus 31 integrally stowable within housing 12. Screen 18 and its related software serve as a sensor for character recognition and also display a virtual keyboard. This software keyboard replicates a standard alphanumeric keyboard. The user places the cursor in the location on screen 18 where text is desired, touches screen 18 on the desired key of the displayed virtual keyboard and the character of that key appears next to the cursor. Text may also be entered by tracing alphanumeric characters on screen 18 with stylus 31. Character recognition software recognizes the tracing and enters the appropriate character next to the cursor.

Mechanical control buttons, referred to hereinafter in the aggregate as buttons 20 activate the on/off, application and mode selection functions of device 10. Buttons 20, along with joystick 27, are also the primary input means for playing games. The preferred embodiment includes a plurality of buttons, the functions of which are those customarily associated with internet access/PDA/cellular communication devices such as, for example, the following: on/off 21, communicator/phone application 22, tools/status bar/browser application 23, home/application selection 24, zoom/LCD control 25, and scroller 26.

Buttons 20 are integral to housing 12. Five buttons are located peripheral to screen 18 easily accessible to the fingers and thumb of the user. In further embodiments, a greater or lesser number of buttons 20 could be provided, buttons 20 may be endowed with more, less or different functions; buttons 20 could be of larger or smaller size; and buttons 20 could be in different locations, arranged, for example, to accommodate right handed users, left handed users or those who wish to activate all buttons with one hand.

Joystick 27, which moves the cursor and serves directional scrolling functions, is conveniently located and easily manipulable by a finger or thumb of a user.

Condenser microphone 29 is integral to housing 12 and can be brought close to the mouth of a user for discreet speech by a speaker or can be used as a conference microphone by being placed central to a group of speakers, inputting voice signals within a predetermined radius.

Accordingly, it is a feature of the described preferred embodiment that all elements of input interface 14 which provide user input into device 10 are designed and configured to be easy, convenient and user friendly.

Device 10 communicates with the user via output interface 16. Output interface 16 includes screen 18, which serves as an LCD monochrome or color display screen capable of showing text, graphics and still or moving graphic and photographic images. According to the preferred embodiment, screen 18 has a horizontal dimension of about 80 mm and a vertical dimension of about 60 mm, defining an aspect ratio of about 4:3. Screen 18 displays an image in a horizontal or “landscape” format which replicates the format of a conventional computer screen. Most Web pages are formatted to fit the horizontal dimension or width of a conventional computer screen, although they vary widely in length. Accordingly, screen 18 is capable of displaying the entire width of a standard Web page simultaneously and can scroll vertically in order to display the length of the Web page. Horizontal scrolling is also preferably made available for those rare Web pages having a width which is designed to extend beyond a computer screen.

Output interface 16 further includes built-in speaker 28 and jack 30 for external earphones.

As mentioned hereinabove, one of the primary functions of device 10 is Internet access. Internet access is defined as the ability to visit Web pages and Web sites that form a part of the World Wide Web, to retrieve data therefrom, to deposit date thereat or to send and receive electronic mail (email).

Device 10 includes a Web browser application to enable World Wide Web access. As used herein, the phrase “Web browser” refers to any software application which can display text, graphics, or both from Web pages on World Wide Web sites. Examples of Web browsers include, Netscape navigator, Internet Explorer, Opera and iCab. Web browsers utilize search engines which employ Web spiders to search, find and retrieve data. The phrase “Web page” refers to any document or collection of documents written in a mark-up language (for example: HTML, VRML, XML, WML, or related computer languages) reachable through one specific Internet address or at one specific World Wide Web site, or any document obtainable through a particular URL (Uniform Resource Locator). The phrase “Web site” refers to at least one Web page, and preferably a plurality of Web pages, virtually connected to form a coherent group of interlinked documents.

Buttons 20 are used to engage the Internet access function and bring links and menus to screen 18. The desired links and menu items are selected by touching screen 18 in the appropriate location. To enter text, whether for email, search criteria, or to enter a URL, the keyboard is used. Accordingly, the desired search commands are entered.

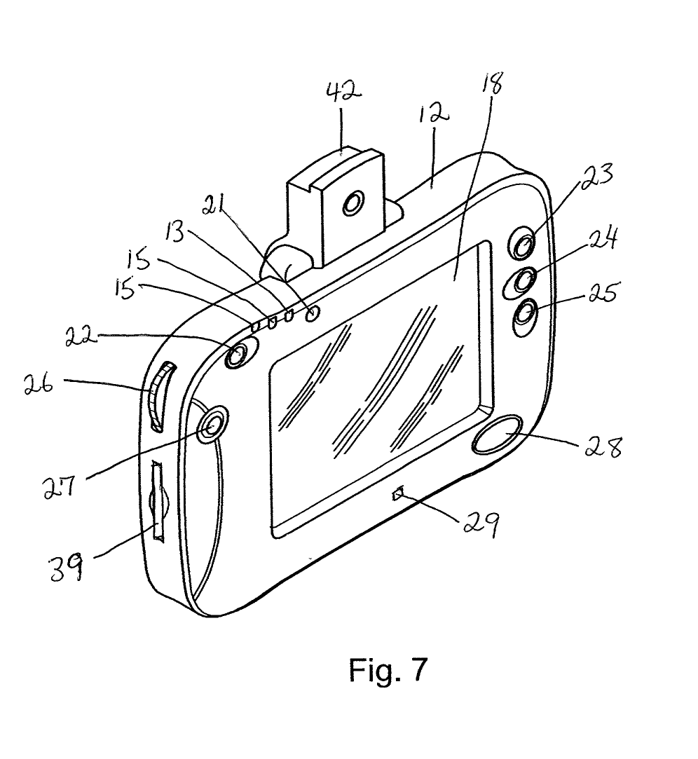

Device 10 thereafter accesses the Internet using system 43 as illustrated in FIG. 7 and as more fully described hereinbefore.

When the World Wide Web is accessed and a desired Web page or Web site is identified, search results are displayed on screen 18. Search results may be Web pages or may consist of links to further Web pages or sites. As stated hereinabove, screen 18 has an aspect ratio similar to that in which a conventional Web page is formatted. As a result, device 10 is capable of convenient and rapid display of Web pages. When the search is completed and the desired data is displayed, this data may be stored, edited for storage, or transmitted to another user client 50. Such transmission is effected by first transmitting the data to communications network 46, which in this case is the Internet; thereafter from the Internet to server 48, which is a dedicated server for communicating with a plurality of user clients 50; and then from server 48 to the desired user client 50.

Another of the primary functions of device 10 is data processing. Accordingly, device 10 serves as a PDA type device which contains a database server containing stored data which may be accessed by a user. As used herein, “PDA” means a standalone portable personal digital assistant unit, able to execute an internally stored database/memory program.

Although the most common application of a PDA device is to operate Personal Information Management (PIM) applications, Device 10 is designed and configured to accept data from a plurality of sources. For example, device 10 may retrieve data from the World Wide Web, as described hereinbefore, or from other database servers forming a part of the World Wide Web; it may input data directly via input interface 14; and it may receive data transferred by user clients with whom it is in communication. Data may be of different content types encompassing publicly available data as published on the World Wide Web or user specific data entered by the user, such as address book information; calendar/agenda information; and personal, financial or other private information.

Because device 10 imports content from a plurality of sources, it has a memory application capable of storing information regardless of the data type, the format in which the data is received, or the source from which it is retrieved. The data stored in the memory of device 10 may be synchronized with the memory in the user's other database servers, such as a home or laptop computer, so that data stored in both devices may be edited by either device. In addition, disposed upon device 10 is memory card slot 39 which allows data retrieval and storage via external disks.

Another primary function of device 10 is communicating with another user client 50 operated by a user. Such communication is preferably effected via a cellular network, although device 10 is capable of communication via other communications networks 46, as hereinbefore described. According to the described preferred embodiment, device 10 preferably serves as a mobile cellular telephone having an antenna, a transmitter, a receiver, and telephone circuitry, and communicates preferably via the GSM cellular network. Device 10 is also capable of communicating on the GPRS network as it is anticipated that shortly it will become widespread practice to replace the GSM network with the GPRS network for cellular communication, as the GPRS network allows the transmission of packet data in addition to voice data.

To enable such communication, device 10 includes a wireless communication port 34, which may employ infrared or radio frequency transmission to access the communications network. As stated hereinbefore, device 10 includes Blue Tooth technology to provide maximum versatility and mobility.

According to the above description, the preferred embodiment of the present invention represents a synergy of features in a hand held device that provides Internet access, processes data and communicates with remote users, and further incorporates within these functions an integral yet mobile digital camera, all combined in a small housing that may be securely and comfortably held in one hand.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Although the invention has been described in conjunction with a specific embodiment thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A hand held and operable Internet access/personal digital assistant(PDA)/cellular communication device comprising:
(a) a housing being sufficiently small so as to be held by one hand of a user;
(b) a touch sensitive screen being engaged in said housing, said touch sensitive screen serving as a display screen and also as a part of a user input interface, said touch sensitive screen having horizontal and vertical dimensions defining an aspect ratio of about 4:3 and constituting at least 50% of a front face of the device; and
(c) a rear bridge being connected to or integrally formed with a back of said housing, said rear bridge being constructed and positioned so as to create a gap between said rear bridge and said back of said housing, said gap being to allow a user to securely grip said device;
said device being designed and configured for accessing the Internet, processing data, and communicating with at least one user client.

2. The device of claim 1, further comprising an integral or mountable digital camera being pivotally engaged by said housing, said digital camera being movable relative to said device such that said digital camera is positionable in at least one first direction facing a first field-of-view in front of said front face of said device and is re-positionable in at least one second direction facing a second field-of-view behind said back of said device.

3. The device of claim 1, wherein said communication between said device and said at least one user client is effected via a communications network.

4. The device of claim 3, wherein said at least one user client is selected from the group consisting of a computer, a cellular telephone and a personal digital assistant.

5. The device of claim 1, further comprising a data communication port.

6. The device of claim 1, further comprising a memory for storing data.

7. The device of claim 1, wherein said touch sensitive screen displays a virtual keyboard and/or serves as a sensor for character recognition.

8. The device of claim 1, wherein said user input interface further includes one or more buttons disposed in said front face of said housing, an integral joystick operable by a user and a microphone integral to said housing.

9. The device of claim 1, further comprising an output interface comprising said display screen and a speaker.

10. The device of claim 1, wherein said display screen being capable of displaying a full width of a Web page.

11. The device of claim 1, which is designed and configured for communicating with a base unit.

12. The device of claim 1, which is designed and configured for communicating with a server.

13. The device of claim 1, wherein said rear bridge is designed for holding a batery for powering the device.

14. A hand held and operable Internet access/personal digital assistant (PDA)/cellular communication device comprising:
(a) a housing being sufficiently small so as to be held by one hand of a user;
(b) a touch sensitive screen being engaged in said housing, said touch sensitive screen serving as a display screen and also as part of a user input interface, said touch sensitive screen having horizontal and vertical dimensions defining an aspect ratio of about 4:3 and constituting at least 50% of a front face of the device; and
(c) an integral or mountable digital camera being pivotally engaged by said housing, said digital camera being movable relative to said device such that said digital camera is positionable in at least one direction facing a first field-of-view in front of said front face of said device and re-positionable in at least one direction facing a second field-of-view behind said back of said device;
said device being designed and configured for accessing the Internet, processing data, and communicating with at least one user client.

15. The device according to claim 14, further comprising a rear bridge being connected to or integrally formed with a back of said housing, said rear bridge being constructed and positioned so as to create a gap between said rear bridge and said back of said housing, said gap being to allow a user to securely grip said device.

16. The device of claim 15, wherein said rear bridge is designed for holding a batery for powering the device.

17. The device of claim 14, wherein said communication between said device and said at least one user client is effected via a communications network.

18. The device of claim 16, wherein said at least one user client is selected from the group consisting of a computer, a cellular telephone and a personal digital assistant.

19. The device of claim 14, further comprising a data communication port.

20. The device according to claim 14, further comprising a memory for storing data.

21. The device of claim 14, wherein said touch sensitive screen displays a virtual keyboard and/or serves as a sensor for character recognition.

22. The device of claim 14, wherein said user input interface further includes one or more buttons disposed in said front face of said housing, an integral joystick operable by a user and a microphone integral to said housing.

23. The device of claim 14, further comprising an output interface comprising said display screen and a speaker.

24. The device of claim 14, wherein said display screen being capable of displaying a full width of a Web page.

25. The device of claim 14, which is designed and configured for communicating with a base unit.

26. The device of claim 15, which is designed and configured for communicating with a server.
